(19) United States
(12) Patent Application Publication
(10) Pub. No.: US 2026/0016133 A1
(43) Pub. Date: Jan. 15, 2026

(54) VEHICLE LAMP

(71) Applicant: Stanley Electric Co., Ltd., Tokyo (JP)

(72) Inventors: Kazuki HONDA, Tokyo (JP); Shota NISHIMURA, Tokyo (JP)

(21) Appl. No.: 18/993,928

(22) PCT Filed: Jun. 26, 2023
(86) PCT No.: PCT/JP2023/023610

§ 371 Date: Jan. 13, 2025

(30) Foreign Application Priority Data
Jul. 13, 2022 (JP) 2022-112525

(51) Int. Cl. F21S 41/147; F21S 41/151; F21S 41/26; F21S 41/663; F21W 102/155; F21Y 115/10

(52) U.S. Cl. CPC F21S 41/147; F21S 41/151; F21S 41/26; F21S 41/663; F21W 2102/155; F21Y 2115/10

(57) ABSTRACT

The vehicle lamp includes: multiple light-emitting elements; a lens that transmits light emitted from each of the multiple light-emitting elements; and a housing that passes through the light that transmitted through the lens; where the multiple light-emitting elements include one first light-emitting element disposed on a left end side when mounted on a vehicle, and one second light-emitting element disposed on a right end side when mounted on the vehicle; where a first light emitted from the first light-emitting element and transmitted through the lens passes through the housing so as to spread biasedly in a rightward direction with respect to a front-rear direction when mounted on the vehicle; and where a second light emitted from the second light-emitting element and transmitted through the lens passes through the housing so as to spread biasedly in a leftward direction with respect to the front-rear direction when mounted on the vehicle.

This application is a U.S. National Stage Application under 35 U.S.C § 371 of International Patent Application No. PCT/JP2023/023610 filed Jun. 26, 2023, which claims the benefit of priority under 35 U.S.C. § 119 to Japanese Patent Application No. 2022-112525 filed Jul. 13, 2022, the disclosures of all of which are hereby incorporated by reference in their entireties.

### TECHNICAL FIELD

The present disclosure relates to a vehicle lamp.

### BACKGROUND ART

The vehicle lamp described in Japanese Unexamined Patent Application Publication No. 2017-047815 (Patent Document 1) comprises a first lamp unit for forming a high beam light distribution pattern, and a second lamp unit for forming a low beam light distribution pattern. The first lamp unit has five light emitting modules, and is disposed closer to the center of an vehicle than the second lamp unit. The second lamp unit has three light emitting modules 46, and is disposed closer to the left end of the vehicle than the first lamp unit.

### PRIOR ART DOCUMENT

### Patent Document

[Patent Document 1] Japanese Unexamined Patent Application Publication No. 2017-047815

### SUMMARY OF THE INVENTION

### Technical Problem

In a specific aspect, it is an object of the present disclosure to provide a vehicle lamp capable of improving designability.

### Solution to the Problem

A vehicle lamp according to one aspect of the present disclosure is a vehicle lamp including: (a) a plurality of light-emitting elements; (b) a lens that transmits light emitted from each of the plurality of light-emitting elements; and (c) a housing that passes through the light that has transmitted through the lens; (d) where the plurality of light-emitting elements include at least one first light-emitting element disposed on a left end side when mounted on a vehicle, and at least one second light-emitting element disposed on a right end side when mounted on the vehicle; (e) where a first light emitted from the first light-emitting element and transmitted through the lens passes through the housing so as to spread biasedly in a rightward direction with respect to a front-rear direction when mounted on the vehicle; and (f) where a second light emitted from the second light-emitting element and transmitted through the lens passes through the housing so as to spread biasedly in a leftward direction with respect to the front-rear direction when mounted on the vehicle.

According to the above configuration, a vehicle lamp capable of improving designability can be obtained.

### BRIEF DESCRIPTION OF THE DRAWINGS

FIG. 1 is a disassembled oblique view of the optical elements of a vehicle lamp according to one embodiment.

FIG. 2(A) and FIG. 2(B) are diagrams showing simplified views of cross-sectional structure of a vehicle lamp.

FIG. 3(A) and FIG. 3(B) are diagrams showing the configuration of a vehicle lamp of a comparative example, respectively.

FIG. 4(A) is a schematic diagram showing the operating condition of the light-emitting elements when only a low beam is emitted.

FIG. 4(B) is a schematic diagram showing the operating condition of the light-emitting elements when emitting a low beam and a high beam.

FIG. 5(A) to FIG. 5(E) are diagrams showing light distribution patterns produced by light emitted from each light-emitting element.

FIG. 6(A) is a diagram showing a low beam light distribution pattern.

FIG. 6(B) is a diagram showing the light distribution pattern of a low beam and a high beam.

FIG. 7(A) and FIG. 7(B) are diagrams for explaining a lens configuration example for causing the light emitted from a light-emitting element to spread biasedly to a specific direction.

FIG. 8 is a cross-sectional view showing a more detailed working example of the lens.

### MODE FOR CARRYING OUT THE INVENTION

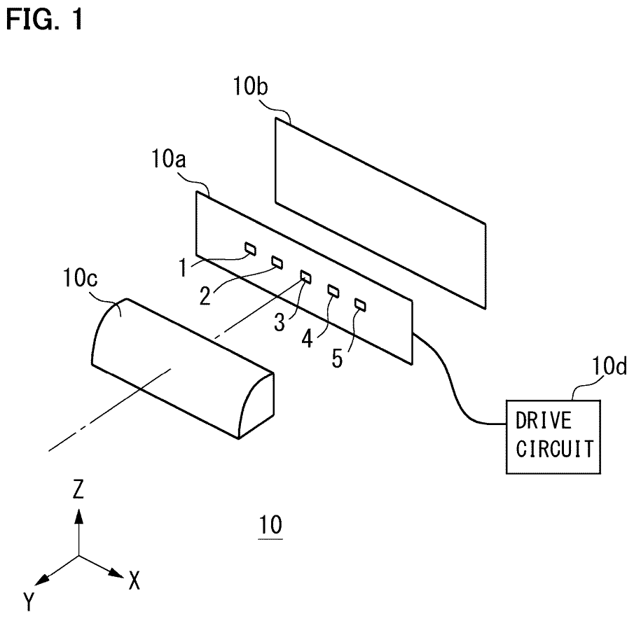

FIG. 1 is a disassembled oblique view of the optical elements of a vehicle lamp according to one embodiment. The vehicle lamp 10 of the present embodiment is configured to include a light source substrate 10a, a heat sink 10b, a lens 10c, and a drive circuit 10d.

The light source substrate 10a has a plurality of light-emitting elements 1 to 5 arranged along the left-right direction (X direction in the figure) when mounted on a vehicle. In the present embodiment, an LED is considered as an example of each of the light-emitting elements 1 to 5, but each of the light-emitting elements 1 to 5 may also be a laser element.

The heat sink 10b is used to dissipate heat from the

light source substrate 10a and is disposed on the rear side of the light source substrate 10a.

The lens 10c is disposed on the front side of the substrate 10a and transmits the light emitted from each of light-emitting elements 1 to 5 to form a light distribution pattern.

The drive circuit 10d is connected to the light source substrate 10a and drives each of the light-emitting elements 1 to 5.

Among the light-emitting elements 1 to 5 on the light source substrate 10a, light-emitting elements 2 and 4 are used to form a high beam, and light-emitting elements 1, 3, and 5 are used to form a low beam. Light-emitting elements 1 and 5 are located at the left and right ends, respectively. Light-emitting element 3 is located midway between light-emitting element 1 and light-emitting element 5. Light-emitting element 2 is located between light-emitting element 1 and light-emitting element 3. Light-emitting element 4 is located between light-emitting element 3 and light-emitting element 5.

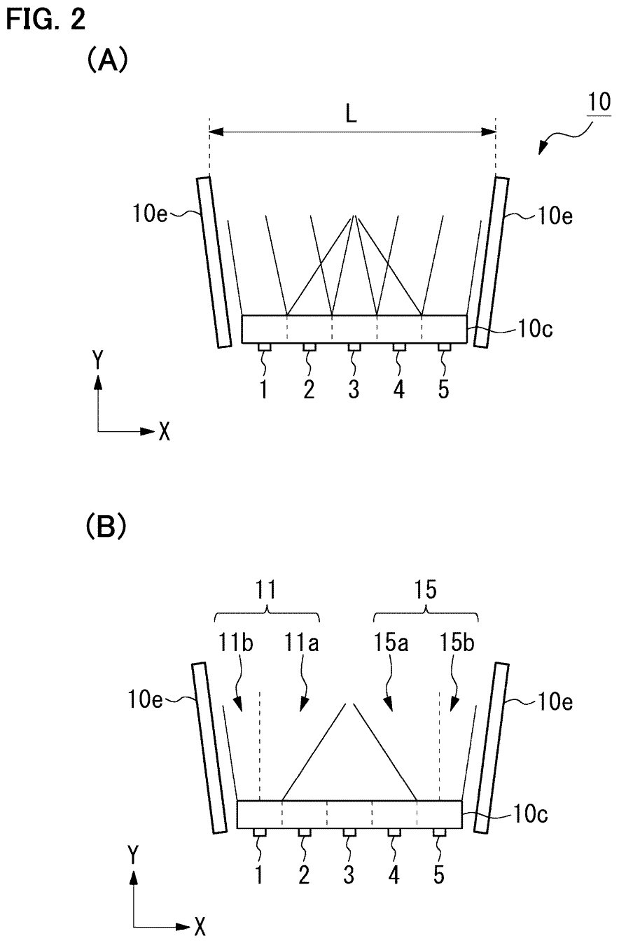

FIG. 2(A) and FIG. 2(B) are diagrams showing simplified views of cross-sectional structure of a vehicle lamp. As described above, the light emitted from each of the light-emitting elements 1 to 5 of the vehicle lamp 10 is collected by the lens 10c and irradiated forward of the vehicle. A housing (extension) 10e is provided in front of the lens 10c to narrow the light emitted from each of the light-emitting elements 1 to 5 to a certain range and allows it to pass through. The light emission surface of the lens 10c is located on the side closer to a second opening on the lower side of the housing 10e in the figure. As shown in the figure, this second opening has a smaller diameter than a first opening on the upper side of the housing 10e in the figure.

Among each of the light-emitting elements 1 to 5, the light emitted from each of the light-emitting elements 2 to 4, which are arranged between light-emitting elements 1, 5 on the left and right ends in the left-right direction when mounted on the vehicle (X direction in the figure), is collected by the lens 10c and spreads out almost symmetrically with respect to the front-rear direction when mounted on the vehicle (Y direction in the figure), and is irradiated forward of the vehicle.

On the other hand, as shown in FIG. 2(B), which extracts the light emitted from each of the light-emitting elements 1 and 5, the light from the light-emitting elements 1 and 5 spreads asymmetrically with respect to the Y direction and is emitted from the lens 10c.

In detail, light 11 from light-emitting element 1 has more component 11a traveling in the rightward direction with respect to the Y direction than component 11b traveling in the leftward direction. And this light 11 emits from the lens 10c toward the side away from the inner wall of the housing 10e on the side closest to itself, so as to spread biasedly in the opposite direction (the right side in the illustrated example) to its own position (position on the left side in the illustrated example) among the light-emitting elements 1 to 5.

Further, the light 15 from the light-emitting element 5 has more component 15a traveling in the leftward direction with respect to the Y direction than component 15b traveling in the rightward direction. And this light 15 emits from the lens 10c toward the side away from the inner wall of the housing 10e on the side closest to itself, so as to spread biasedly in the opposite direction (the left side in the illustrated example) to its own position (position on the right side in the illustrated example) among the light-emitting elements 1 to 5.

These light-emitting elements 1 and 5 are used for forming a low beam, and since it is necessary to emit light at a wider angle, the light spread angle is set larger than that of the other light-emitting elements 2 to 4. Despite this, the opening diameter L of the housing 10e can be narrowed by shifting the spread direction.

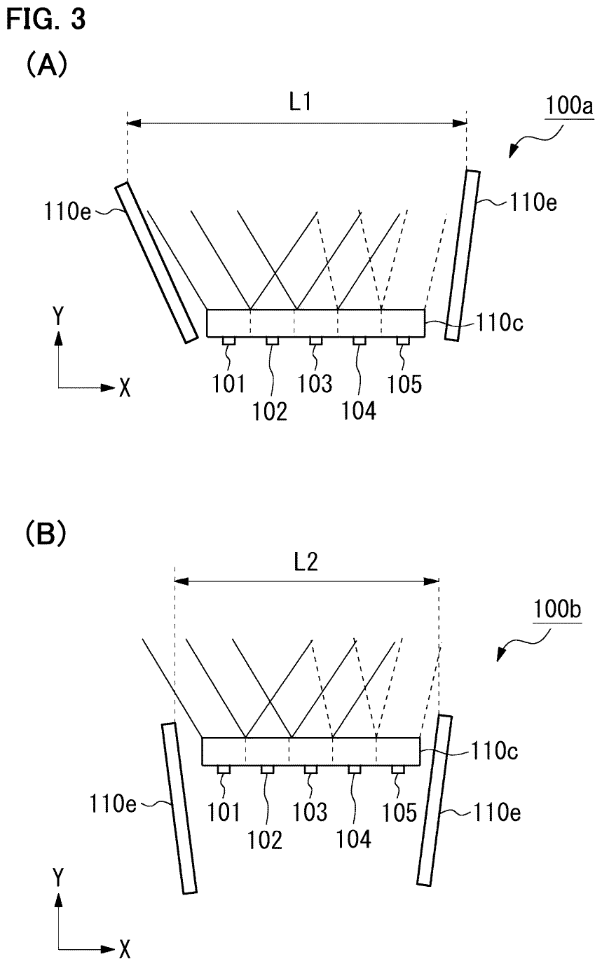

FIG. 3(A) and FIG. 3(B) are diagrams showing the configuration of a vehicle lamp of a comparative example, respectively. In each figure, the vehicle lamps 100a, 100b of the comparative examples each includes light-emitting elements 101, 102, 103, 104, 105, a lens 110c, and a housing 110e. In each of the vehicle lamps 100a, 100b of the comparative examples, the light-emitting elements 101 to 103 arranged on the left side of the figure are used for forming a low beam, and the light-emitting elements 104, 105 arranged on the right side of the figure are used for forming a high beam. And the light-emitting elements 101 to 103 are set to have a larger light spread angle than the light-emitting elements 104 and 105.

In the comparative vehicle lamp 100a shown in FIG. 3(A), the opening diameter L1 of the housing 110e is made larger than that of the vehicle lamp 10 of the above-described embodiment in order to ensure that the light from each of the light-emitting elements 101 to 103 is not blocked by the housing 110e. As a result, this makes the vehicular lamp 100a more conspicuous, which is undesirable from appearance design standpoint.

On the other hand, as in the comparative vehicle lamp 100b shown in FIG. 3(B), if the light-emitting elements 101 to 105 and lens 110c are arranged close to the upper opening of the housing 110e in the figure so that the light from the light-emitting elements 101 to 103 is not blocked by the housing 110e, the opening diameter L2 of the housing 110e can be made smaller, however the presence of the lens 110c and the light-emitting elements 101, etc. becomes more conspicuous, which is also undesirable from appearance design standpoint.

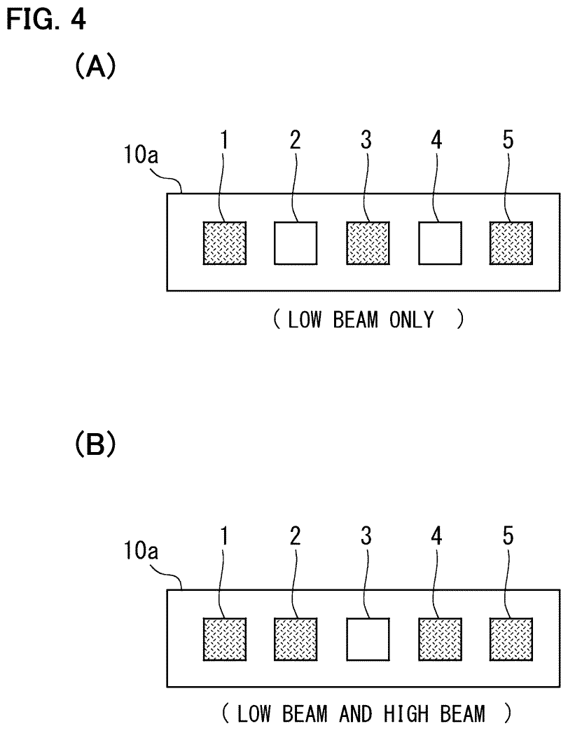

FIG. 4(A) is a schematic diagram showing the operating condition of the light-emitting elements when only a low beam is emitted. As shown in the figure, in the vehicle lamp 10 of the present embodiment, a low beam is formed by transmitting light emitted from each of the light-emitting elements 1, 3, and 5 among the light-emitting elements 1 to 5 through the lens 10c. Each of the light-emitting elements 1 and 5 is turned on when a driving voltage is applied from the drive circuit 10d.

FIG. 4(B) is a schematic diagram showing the operating condition of the light-emitting elements when emitting a low beam and a high beam. In the vehicle lamp 10 of the present embodiment, as shown in the figure, a low beam is formed by the light emitted from each of the light-emitting elements 1 and 5 among the light-emitting elements 1 to 5 transmitting through the lens 10c, and a high beam is formed by the light emitted from each of the light-emitting elements 2 and 4 transmitting through the lens 10c. Each of the light-emitting elements 1 to 5 is turned on when a driving voltage is applied from the drive circuit 10d.

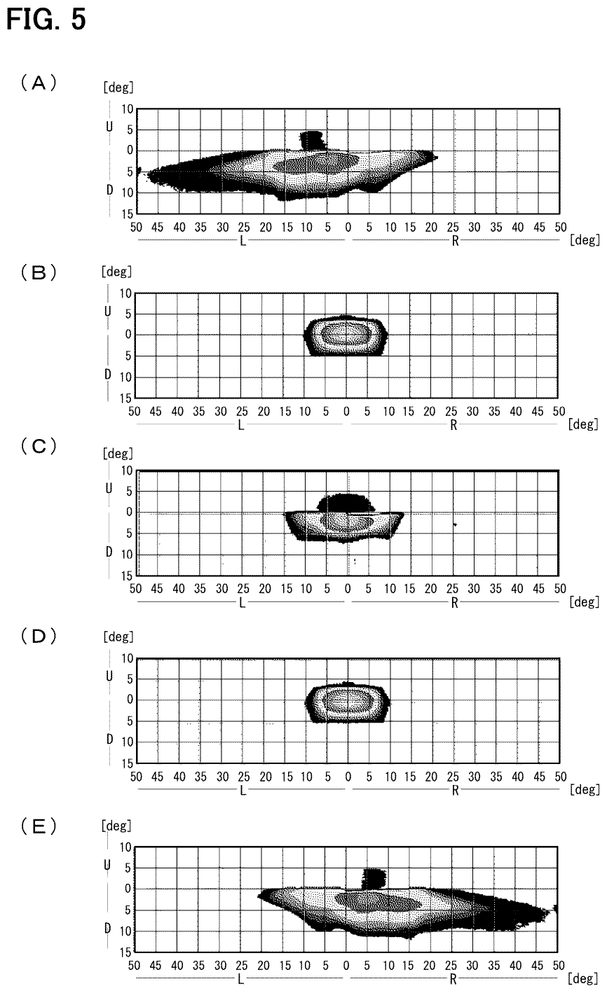

FIG. 5(A) to FIG. 5(E) are diagrams showing light

distribution patterns produced by light emitted from each light-emitting element. FIG. 5(A) shows the light distribution pattern obtained by transmitting light emitted from light-emitting element 5 through the lens 10c. Specifically, this is a light distribution pattern that is mainly irradiated widely below the horizon, spreading from the center (0°) in front of the vehicle to the left side (L side).

FIG. 5(B) shows the light distribution pattern obtained by transmitting light emitted from light-emitting element 2 through the lens 10c. Specifically, this is a light distribution pattern that is a relatively narrow irradiation range that is mainly irradiated from approximately 5° below the horizon (D side) to approximately 5° above (U side), and is irradiated within a range of approximately 10° to the left and right from the center (0°) in front of the vehicle.

FIG. 5(C) shows the light distribution pattern obtained by transmitting light emitted from light-emitting element 3 through the lens 10c. Specifically, this is a light distribution pattern that is mainly irradiated from approximately 7° below the horizon (D side) to approximately 4° above (U side), and below the horizon, the light is irradiated in a range of approximately 15° to the left and right from the center (0°) in front of the vehicle, and above the horizon, the light is irradiated in a range of approximately 6° to the left and right from the center of the front of the vehicle. This light distribution pattern brightly irradiates a spot approximately 10 m from the vehicle in the center in front of the vehicle.

FIG. 5(D) shows the light distribution pattern obtained by transmitting light emitted from light-emitting element 4 through the lens 10c. Specifically, similar to the light-emitting element 2 described above, this is a light distribution pattern that has a relatively narrow irradiation range and is irradiated mainly from approximately 5° below the horizon (D side) to approximately 5° above (U side), and is irradiated in a range of approximately 10° to the left and right from the center (0°) in front of the vehicle.

FIG. 5(E) shows the light distribution pattern obtained by transmitting light emitted from light-emitting element 1 through the lens 10c. Specifically, this is a light distribution pattern that is irradiated widely, mainly below the horizon, spreading from the center (0°) in front of the vehicle to the right side (R side).

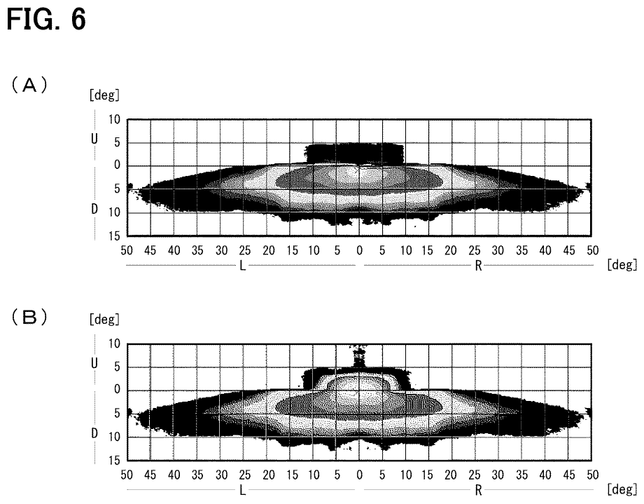

FIG. 6(A) is a diagram showing a low beam light distribution pattern. This light distribution pattern is obtained by combining the light distribution patterns shown in FIG. 5(A), FIG. 5(C) and FIG. 5(E) described above. As shown in the figure, this is a light distribution pattern that mainly irradiates below the horizon, in other words, a light distribution pattern that mainly irradiates an area relatively close to the vehicle.

FIG. 6(B) is a diagram showing the light distribution pattern of a low beam and a high beam. This light distribution pattern (first light distribution pattern) is obtained by combining the light distribution patterns shown in FIG. 5(A), FIG. 5(B), FIG. 5(D), and FIG. 5(E) described above. The light distribution pattern shown in the figure is a superposition of a low beam light distribution pattern that mainly irradiates below the horizon and a high beam light distribution pattern that irradiates the distant area in front of the center of the vehicle. That is, this is a light distribution pattern that irradiates light both to the area relatively close to the vehicle and to the area relatively far from the vehicle.

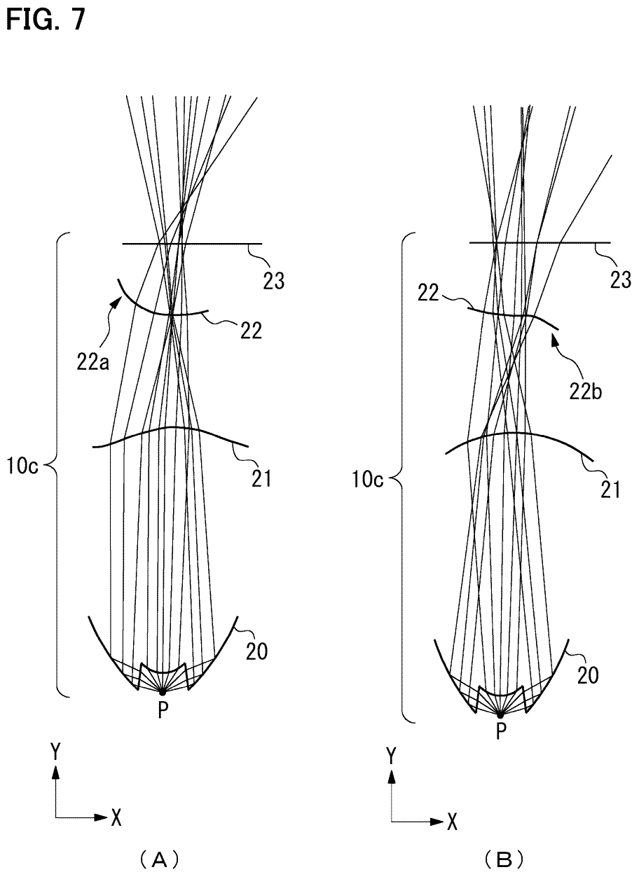

FIG. 7(A) and FIG. 7(B) are diagrams for explaining a lens configuration example for causing the light emitted from a light-emitting element to spread biasedly in a specific direction. In each figure, P indicates the light emission point of light-emitting element 1 (or light-emitting element 5), and 21 to 23 indicate refractive index boundary surfaces. Of the refractive index boundary surfaces, the area between refractive index boundary surface 20 and refractive index boundary surface 21, and the area between refractive index boundary surface 22 and refractive index boundary surface 23 are each filled with the constituent material of the lens 10c, and the area between refractive index boundary surface 21 and refractive index boundary surface 22 is a gap in which air exists. The refractive index boundary surface 23 is also the light emission surface of the lens 10c.

In the lens 10c of the configuration example shown in FIG. 7(A), the curvature is set relatively strong (large) in portion 22a of the refractive index boundary surface 22 on the left side in the figure. As a result, of the light emitted from the light emission point P and enters the lens 10c, the light component that enters portion 22a of the refractive index boundary surface 22 is refracted more strongly, and is further refracted at refractive index boundary surface 23 and travels biasedly to the rightward direction in the figure. With the lens 10c configured in this way, the light emitted from each light-emitting element 1 and 5 can be made to travel so that it spreads biasedly in a specific direction. Here, note that if each of the refractive index boundary surfaces 20 to 23 is inverted in the X direction in the figure, the direction of light bias can be reversed.

In the lens 10c of the configuration example shown in FIG. 7(B), the curvature is set to be relatively weak (small) in portion 22b of the refractive index boundary surface 22 on the right side in the figure. As a result, of the light emitted from the light emission point P and enters the lens 10c, the light component that enters portion 22b of the refractive index boundary surface 22 is refracted weaker, and is further refracted at refractive index boundary surface 23 and travels biasedly to the rightward direction in the figure. With the lens 10c configured in this way as well, the light emitted from each light-emitting element 1 and 5 can be made to travel so that it spreads biasedly in a specific direction. Here, note that if each refractive index boundary surface 20 to 23 is inverted in the X direction in the figure, the direction of light bias can be reversed.

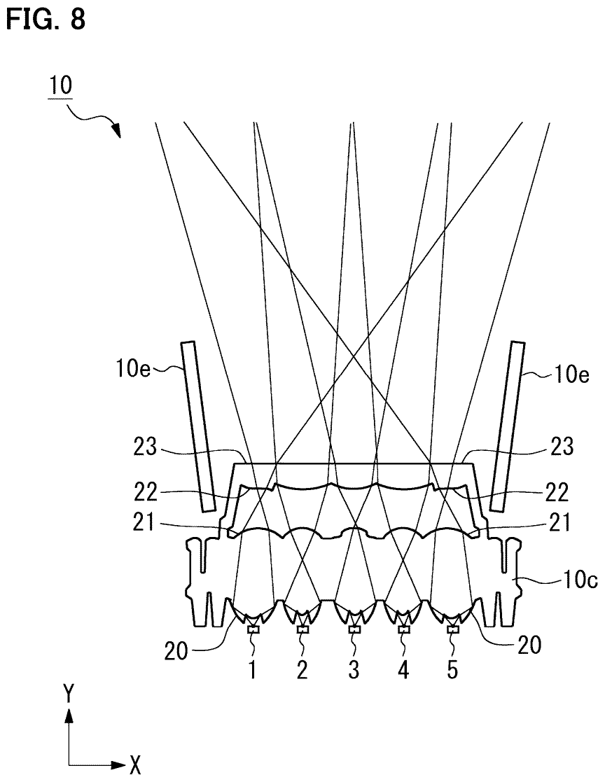

FIG. 8 is a cross-sectional view showing a more detailed working example of the lens. The lens 10c of the working example is shown in a state where it is incorporated into the housing 10e. Here, for clarity of light rays indicated by thin lines, hatching is omitted. As an example, the lens 10c of the working example having the refractive index boundary surface described with reference to FIG. 7(B) is shown. The refractive index boundary surfaces 20 to 23 described above are used as the refractive index boundary surfaces for the light emitted from each of the light-emitting elements 1 and 5. Here, although not shown, the refractive index boundary surface described with reference to FIG. 7(A) may also be used. The refractive index boundary surface 23, which is also the light emission surface of the lens 10c, is disposed on the side close to the second opening on the lower side of the housing 10e in the figure. As shown, this second opening has a smaller diameter than the first opening on the upper side of the housing 10e in the figure.

According to the above-described embodiments, a vehicle lamp capable of improving designability can be obtained.

Here, note that the present disclosure is not limited to the content of the above described embodiments, and various modifications can be made within the scope of the gist of the present disclosure. For example, in the above-described embodiments, a vehicle lamp is disclosed having a mixed configuration of light-emitting elements responsible for forming a high beam and light-emitting elements responsible for forming a low beam, but the vehicle lamp may be configured to be divided into a high-beam formation and a low-beam formation. Specifically, the vehicle lamp may be configured such that all of the light-emitting elements 1 to 5 in the above-described embodiments are responsible for forming a high beam. Similarly, the vehicle lamp may be configured such that all of the light-emitting elements 1 to 5 in the above-described embodiments are responsible for forming a low beam.

Further, in the above described embodiments, light-emitting elements 1, 3, and 5 are responsible for forming a low beam, and light-emitting elements 2 and 4 are responsible for forming a high beam, but these roles may be reversed. Further, light-emitting elements 1 to 5 may be responsible for forming light other than a low beam and a high beam (for example, fog lamps, tail lamps, etc.). Furthermore, the number of light-emitting elements is not limited to five as disclosed in the above described embodiments.

In either case, the light emitted from each light-emitting element 1, 5 corresponding to the left and right directions when mounted on the vehicle can be made to spread biasedly in a specific direction without increasing the opening diameter of the housing 10e, thereby improving designability. Here, note that when the number of light-emitting elements is increased, instead of having one light-emitting element on each of the left and right ends when mounted on a vehicle, one can have two or more light-emitting elements on each of the left and right ends and have them emit light biased in a specific direction.

The present disclosure has features as appended below.

### Appendix 1

A vehicle lamp including:
a plurality of light-emitting elements;
a lens that transmits light emitted from each of the plurality of light-emitting elements; and
a housing that passes through the light that has transmitted through the lens;
where the plurality of light-emitting elements include at least one first light-emitting element disposed on a left end side when mounted on a vehicle, and at least one second light-emitting element disposed on a right end side when mounted on the vehicle;
where a first light emitted from the first light-emitting element and transmitted through the lens passes through the housing so as to spread biasedly in a rightward direction with respect to a front-rear direction when mounted on the vehicle; and
where a second light emitted from the second light-emitting element and transmitted through the lens passes through the housing so as to spread biasedly in a leftward direction with respect to the front-rear direction when mounted on the vehicle.

### Appendix 2

The vehicle lamp according to appendix 1,
where the first light has a greater component traveling in the rightward direction than the component traveling in the leftward direction with respect to the front-rear direction when mounted on the vehicle, and
where the second light has a greater component traveling in the leftward direction than the component traveling in the rightward direction with respect to the front-rear direction when mounted on the vehicle.

### Appendix 3

The vehicle lamp according to appendix 1 or 2,
where the housing has a first opening and a second opening having a diameter smaller than that of the first opening, and
where the lens has a light emission surface disposed on a side of the housing closer to the second opening, and emits the first light and the second light from the light emission surface toward the first opening.

### Appendix 4

The vehicle lamp according to any one of appendices 1 to 3,
where the plurality of light-emitting elements have one or more third light-emitting element disposed between the first light-emitting element and the second light-emitting element, and
where a third light emitted from the third light-emitting element and transmitted through the lens passes through the housing so as to spread approximately symmetrically with respect to the front-rear direction when mounted on the vehicle.

### Appendix 5

The vehicle lamp according to appendix 4,
where the first light and the second light are emitted at a wider angle than the third light.

### REFERENCE SIGNS LIST

1, 2, 3, 4, 5: Light-emitting element
10: Vehicle lamp
10a: Light source substrate
10b: Heat sink
10c: Lens
10d: Drive circuit
10e: Housing
20, 21, 22, 23: Refractive index boundary surface

1. A vehicle lamp comprising:
a plurality of light-emitting elements;
a lens that transmits light emitted from each of the plurality of light-emitting elements; and
a housing that passes through the light that has transmitted through the lens;
wherein the plurality of light-emitting elements include at least one first light-emitting element disposed on a left end side when mounted on a vehicle, and at least one second light-emitting element disposed on a right end side when mounted on the vehicle;
wherein a first light emitted from the first light-emitting element and transmitted through the lens passes through the housing so as to spread biasedly in a rightward direction with respect to a front-rear direction when mounted on the vehicle; and
wherein a second light emitted from the second light-emitting element and transmitted through the lens passes through the housing so as to spread biasedly in a leftward direction with respect to the front-rear direction when mounted on the vehicle.

2. The vehicle lamp according to claim 1,
wherein the first light has a greater component traveling in the rightward direction than the component traveling in the leftward direction with respect to the front-rear direction when mounted on the vehicle, and
wherein the second light has a greater component traveling in the leftward direction than the component traveling in the rightward direction with respect to the front-rear direction when mounted on the vehicle.

3. The vehicle lamp according to claim 1,
wherein the housing has a first opening and a second opening having a diameter smaller than that of the first opening, and
wherein the lens has a light emission surface disposed on a side of the housing closer to the second opening, and emits the first light and the second light from the light emission surface toward the first opening.

4. The vehicle lamp according to claim 1,
wherein the plurality of light-emitting elements have one or more third light-emitting element disposed between the first light-emitting element and the second light-emitting element, and
wherein a third light emitted from the third light-emitting element and transmitted through the lens passes through the housing so as to spread approximately symmetrically with respect to the front-rear direction when mounted on the vehicle.

5. The vehicle lamp according to claim 4,
wherein the first light and the second light are emitted at a wider angle than the third light.

6. The vehicle lamp according to claim 1,
wherein, among the plurality of light-emitting elements, light-emitting elements other than the first light-emitting element and the second light-emitting element are disposed between the first light-emitting element and the second light-emitting element,
wherein the light emitted from the plurality of light-emitting elements forms a low beam and a high beam by transmitting through the lens, and
wherein, among the plurality of light-emitting elements, the light emitted from the first light-emitting element and the second light-emitting element forms at least a part of the low beam by transmitting through the lens.
